(19) United States
(12) Patent Application Publication
(10) Pub. No.: US 2014/0304153 A1
(43) Pub. Date: Oct. 9, 2014

(54) METHOD AND A DEVICE FOR BANK NOTE HANDLING

(71) Applicant: Yngve Johnsson, Stockholm (SE)

(72) Inventor: Yngve Johnsson, Stockholm (SE)

(21) Appl. No.: 14/356,619

(22) PCT Filed: Nov. 8, 2012
(86) PCT No.: PCT/SE2012/000183

§ 371 Date: May 7, 2014

(30) Foreign Application Priority Data
Nov. 10, 2011 (SE) SE1100839-8

(51) Int. Cl. G06Q 20/32; G06K 15/02; G06Q 20/10

(52) U.S. Cl. CPC G06Q 20/3278; G06Q 20/10; G06K 15/021
USPC 705/39

(57) ABSTRACT

A method for accomplishing payment by means of bank notes (1) comprising the steps of—receipt of individual bank notes (1) by a provider (1″) of goods or services; —registration of a monetary value of the bank notes; —destruction of the bank notes received and registered and—transmission of data representing said monetary value of the received, registered and destroyed bank notes to a fmancial institution (11). The method is further characterized in the steps of—providing said individual bank notes to be received with an RFID-configuration (2, 4, 5) for identification of the bank notes, including the bank note monetary value; —detecting the RFID-configurations as a basis for said data representing the monetary value of the received, registered and destroyed bank notes. The present invention further concerns a system for accomplishing

### TECHNICAL FIELD

The present invention relates to a method according to the introductory portion of the attached claim 1.

The invention also relates to a device according to the attached claim 9.

### BACKGROUND

Cash in the form of, primarily, bank notes have been used since long and is, in spite of a number of drawbacks, still commonly used as means for payment. Among the drawbacks a most severe one is that it attracts criminal elements. Thus, criminal acts in the form of robberies directed towards banks, shops and value transports are very common and cause, apart from the loss of monetary value, severe problems, even death, for innocent persons involved during such acts.

Another severe problem is that bank notes are forged and forged bank notes are often extremely difficult to detect during normal circulation of bank notes.

Of course many attempts have been made and different technical solutions have been suggested to solve problems connected with cash handling and use. According to one such solution bank notes are destroyed after having been identified and considered with respect to their monetary value, the collected total value thereafter being transferred e.g. electronically to a bank or a corresponding value deposit institution or financial institution. However, automatic identification and monetary value registration, primarily, have been most expensive and not totally reliable to obtain

According to the present invention recent developments in contactless and yet rapid identification of objects and their characteristics are applied to considerably improve technique of the kind discussed above for safe handling of cash in the form of bank notes and further to meet the specific demands with respect to costs which are associated with the specific characteristics according to the present invention.

Such recent developments involve radio frequency (RF) technology and are evolving rapidly with contact-less integrated circuit cards (ICCs) and RF identity (RFID) tags now being in wide use. These RF devices provide speed and convenience of use since they can be presented to a reader at a distance. RFID (Radio Frequency Identification) tags are comprised of a chip and an antenna. The chip carries identification data and a radio frequency signal that can be detected at a distance. The chip receives and transmits the data (such as a product identification number, origin, value etc.) using the antenna. The radio signal is picked up by another source, such as a computer or scanner, which then reads the information that is being transmitted.

In addition, smart labels can also be utilized for identification. These are active RFID labels that can track, process and store data. For instance, smart labels provide manufacturers and distributors with real-time visibility in monetary inventory, and can help monitor conditions and location anywhere in the supply chain.

RFID are generally of two types, low frequency, about 300 KHz, and ultra high frequency, about 902-928 MHz. Both technologies are referred to as RFID as they include a unique identifier for each chip. An international standard ISO/IEC 18000, which describes RFID in the context of supply chain management, is now available, although most current solutions use a number of proprietary specifications.

The most common approach to providing power to the embedded chip is via a modulated magnetic field. Such a magnetic field induces a current in a loop antenna (see for example U.S. Pat. No. 5,473,323 to Jreft, 1993) which is typically laminated as an internal layer of a smart card. Commercially produced RF readers typically have a range of one meter.

The processing and manufacturing interest in conductive inks and other conductive materials that can be press printed lies in the industrial challenge to drastically lower the cost for RFID tags down to 10 cents per unit (or lower) in order to enable its large scale implementation. This requires manufacturing with high-speed ink-jet printers or printing presses to meet actual bank note speed standards. Commonly considered “press printed” processes include printers or printing presses to meet actual bank note speed standards. Commonly considered “press printed” processes include screen printing, ink-jet printing, gravure printing, flexo printing, litho printing, thermal imaging (which can be combined with ink-jet printing for enhanced lateral resolution). Key enabling technologies are printed electronics using various competing as well as complementary materials such as charged inks, charged polymers, organic semiconductors, metal printing, carbon nanotubes, graphene and others. Key in achieving a fundamentally lowered cost in the manufacturing process of RFID tags is to move to disruptive new manufacturing technologies. This involves going from batch processing to so-called inline roll-to-roll manufacturing technologies.

Potential suppliers for printed RFID systems and components suitable for RFID tags on bank notes involves for instance companies such as: Flint Ink Corporation, Precisia LLC, Paralec Inc, CIT Ltd (Conductive Inkjet Technology), Xennia, Carlco, Nano Products, Coates Group (Sun Chemical), QinitiQ, Parelec, Cabot-PEDs, DuPont Electronic Technologies, Poly IC, Plastic Logic, PARC, 3M, Lucent Technologies, QinetiQ, Toyo Ink, IdeOn LLC, and Ciba.

Previously known are bank notes provided with RFID chips. However such known bank notes are expensive and approaches the problem of forgery and secure reading of information and do not consider the advantages useful in association with the present invention.

The object of the present invention is to provide a solution to the problem of providing a low cost and fully reliable technique for identifying and considering and registering value concerning individual bank notes received as payment in a system involving destruction of bank notes, thus limiting exposure of said bank notes to criminal acts.

### SUMMARY OF THE INVENTION

This and further objects of the present invention are obtained by a method according to the accompanying claim 1 and a system according to the accompanying claim 9.

Further advantages are obtained by what is specified in the accompanying dependent claims.

### BRIEF DESCRIPTION OF THE DRAWINGS

A better understanding of the present invention may be had by reading the following detailed description in conjunction with the accompanying drawings in which like details are designated with like designations and in which

FIG. 1 diagrammatically shows a block representation of a first embodiment of a system according to the present invention for handling cash in the form of bank notes;

FIG. 2 diagrammatically shows a first embodiment of a bank note according to the present invention seen towards one of its main extension planes;

FIG. 3 shows a block diagram with steps according to one embodiment of a method to be performed by means of a system according to the present invention;

### DETAILED DESCRIPTION OF EMBODIMENTS OF THE INVENTION

In FIG. 2 a bank note according to the present invention is designated by 1 and 2 designates an RFID-configuration applied to the bank note.

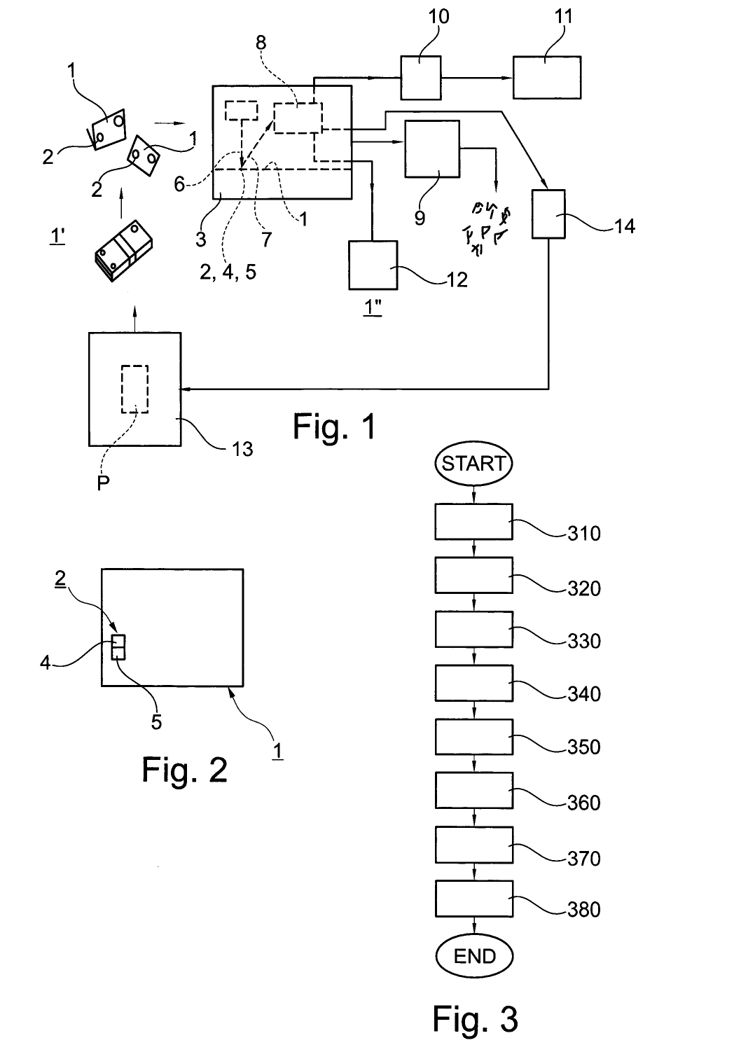

As illustrated in FIG. 1 individual bank notes 1 are, thus, intended to be circulated in a financial system 1′ and to be given to and received by a provider 1″ of goods and/or services as payment for said goods and/or services. The bank notes are intended to be received in e.g. a shop, a department store, a bank or the corresponding facility. Upon receipt, each individual bank note is intended to be treated in a reader unit 3 in order to detect, among other things, the monetary value of the bank note.

Typically, the RFID configuration of the bank notes of the present system comprises an electronic circuit 4 arranged to provide information about the banknote and antenna means 5, an input signal 6 being arranged to be transmitted to the electronic circuit in the reader unit, said circuit being arranged to emit an output signal 7 representing desired information about the bank note, the output signal being transmitted by means of said antenna means for detection in the reader unit.

For registration of detected information a registration device 8 is preferably provided, which device 8 may be a separate unit or may be part of the reader unit 3.

The system further comprises destruction means 9 for destruction of bank notes having been treated in the reader unit and registered by means of the registration device. Preferably, the destruction means provide mechanical destruction of the bank notes in such a way that a reconstruction of the destructed bank notes is not possible, thus making the bank notes completely useless as bank notes.

Transmission means 10 of the present system is provided for transmission of data comprising information detected about the bank notes received, registered and destroyed, said data being intended to be transmitted to e.g. a financial institution 11 and comprising at least the monetary value of the bank notes received, registered and destroyed.

Thus, by means of the RFID configuration of the bank notes and the reader unit the bank notes may be identified contactless from a distance during their motion, the technique involved being suitable for high speed operation and, thus, making it possible to treat a large number of individual bank notes per unit time.

According to preferred embodiments the RFID configuration of the bank notes are of a kind which is printed on the bank notes, which makes it possible to produce the bank notes at a low cost. The material/-s to constitute the RFID configuration, which goes for the electronic circuit portion 4 as well as the antenna portion 5, are of substantially the kinds discussed above and the printing processes to be involved are also of substantially the kind discussed above.

According to preferred embodiments the system is arranged for checking the authenticity of the bank notes received in order to detect forged bank notes, i.e. so called counterfeit. For this purpose the RFID configuration of each bank note comprises information about the origin of the bank note, said information being intended to be transferred from the reader unit to a data base 12 to be checked against reference information corresponding to bank notes edited by a correct authorized institution 13. Preferably, the system is arranged not to register the value of bank notes detected as forged.

According to preferred embodiments information about the bank notes destroyed is collected and transferred to a separate data base 14 as a basis for an authorized institution 13 to edit, print, new bank notes as replacement for the ones destroyed, the new bank notes being intended to be introduced on the market for circulation.

In FIG. 3 steps of the method according to one embodiment of the present invention are given.
In a step 310 bank notes 1 are provided with an RFID configuration 2, preferably by at least one printing process P.
In a following step 320 the bank notes provided with the RFID configuration are circulated via channels normally used, e. g. banks
In a following step 330 individual bank notes are received by a provider of goods and services as payment. Upon receipt the bank notes are deposited into the present system for further processing.

In a following step 340 bank notes thus deposited are treated in a reader unit 3, in which information carried by the individual RFID configuration of each bank note;
In a following step 350, being an optional but yet preferred step, the authenticity of each bank note is checked by means of the information read in the reader unit against reference information stored in a data base;
In a following step 360 information read in the reader unit and comprising at least the monetary value of each bank note treated in the reader unit is registered in a registration unit;
In a following step 370 the bank notes received and registered are destructed and, thus, are made totally useless as payment means/bank notes;
In a following step 380 data representing at least the monetary value of the bank notes received, registered and destroyed is transmitted to a financial institution.

Thus, the present invention offers improved possibilities to provide a method a system to avoid the drawbacks associated with individual bank note handling by adopting destruction of received bank notes as soon as their monetary value has been settled and registered.

By providing the bank notes with an RFID configuration a rapid, remote and accurate identification and monetary detection is made possible. Further, a high speed production of new bank notes is made possible by means of a, preferably continuous, printing process for printed RFID configurations. If desired, a high speed check of the validity and/or correct origin of the bank notes, i. e. the authenticity, may be performed, e. g. by a check in a suitable producer data base. Mechanical destruction may be provided to a low cost, such destruction being very efficient. Further, since the RFID detection is remote, i.e. of a non contact kind, the demands for the order of the bank notes during treatment in the reader unit for detection are quite low.

Thus, the method and the function of the system according to the present invention as well as the advantages compared to prior art should have been made clear above.

Further, the present invention has been described above in association with examples and preferred embodiments. Of course, further examples and preferred embodiments may be imagined without departing from the basic inventive idea.

1-14. (canceled)

15. A method for accomplishing payment by means of bank notes comprising the steps of:
receiving individual bank notes by a provider of goods or services;
registering a monetary value of the bank notes;
destroying the bank notes received and registered;
transmitting data representing said monetary value of the received, registered and destroyed ba(nk notes to a financial institution;
providing said individual bank notes to be received with an RFID-configuration for identification of the bank notes, including the bank note monetary value, by means of a printing process; and
detecting said RFID-configurations as a basis for said data representing the monetary val-ue of the received, registered and destroyed bank notes.

16. The method according to claim 15, further comprising providing said RFID configuration of at least one of the following: charged inks, charged polymers, organic semiconductors, metal printing, carbon nanotubes and grapheme.

17. The method according to claim 15, wherein the step of performing printing of said RFID configuration by means of at least one of the printing processes screen printing, ink-jet printing, gravure printing, flexo printing, litho printing and thermal imaging, which optionally can be combined with ink-jet printing for enhanced lateral resolutio).

18. The method according to claim 15, wherein the step of performing said destruction as substantially mechanical destruction dividing each indi-vidual bank note into quite small pieces.

19. The method according to claim 15, wherein the step of providing information in said RFID configuration for checking the authenticity of each individual bank note.

20. The method according to claim 19, wherein the step of reading and transmitting said information for checking the authenticity to a data base comprising reference information regarding the authenticity and performing said check.

21. The method according to claim 15, wherein the step of providing new bank notes as replacement for the bank notes destroyed.

22. A system for accomplishing payment by means of bank notes including transfer of bank notes to a provider of goods or services, comprising:
means for receiving individual bank notes and for reading information including a monetary value from said individual bank notes;
means for registration of a monetary value of the individual bank notes;
means for destruction of the bank notes received and registered;
means for transmission of data representing said monetary value of the received, registered and destroyed bank notes to a financial institution, wherein said individual bank notes to be received are provided with an RFID-configuration for identification of the individual bank notes including the bank note monetary value, said individual bank notes being provided with said RFID-configuration by means of a printing process; and
means for reading the RFID-configurations as a basis for said data representing the monetary value of the received, registered and destroyed bank notes are provided.

23. The system according to claim 22, wherein said RFID configuration is provided of at least one of the following: charged inks, charged polymers, organic semiconductors, metal printing, carbon nanotubes and grapheme.

24. The system according to claim 22, wherein said means for providing said RFID configuration by means of a printing process provides at least one of the printing processes screen printing, ink-jet printing, gravure printing, flexo printing, litho printing and thermal imaging, which optionally can be combined with ink-jet printing for enhanced lateral resolution.

25. The system according to claim 22, further comprising means for performing said destruction as substantially mechanical destruction by means of which each individual bank note is divided into quite small pieces.

26. The system according to claim 22, wherein said RFID configuration is arranged to provide information for checking the authenticity of each individual bank note.

27. The system according to claim 26, further comprising means for reading and transmitting said information for checking the authenticity to a data base comprising reference information regarding the authenticity and for performing said check.

28. The system according to claim 22, further comprising means for providing new bank notes as replacement for the bank notes destroyed.
